(19) United States
(12) Patent Application Publication
(10) Pub. No.: US 2024/0340629 A1
(43) Pub. Date: Oct. 10, 2024

(54) PUBLIC LAND MOBILE NETWORK (PLMN) SCANNING FOR A PLMN WITH DISCONTINUOUS COVERAGE

(71) Applicant: QUALCOMM Incorporated, San Diego, CA (US)

(72) Inventors: Amer CATOVIC, San Diego, CA (US); Haris ZISIMOPOULOS, London (GB); Stephen William EDGE, Escondido, CA (US); Mungal Singh DHANDA, Slough (GB); Umesh PHUYAL, San Diego, CA (US); Bharat SHRESTHA, San Diego, CA (US); Ayan SENGUPTA, San Diego, CA (US)

(21) Appl. No.: 18/293,309

(22) PCT Filed: Sep. 23, 2022
(86) PCT No.: PCT/US2022/044615

§ 371 Date: Jan. 29, 2024

(30) Foreign Application Priority Data
Sep. 29, 2021 (GR) 20210100645

(51) Int. Cl. H04W 8/02; H04W 48/16; H04W 84/04

(52) U.S. Cl. CPC H04W 8/02; H04W 48/16; H04W 84/042

(57) ABSTRACT

Certain aspects of the present disclosure provide techniques for a UE to select a public land mobile network (PLMN). In general, the present disclosure provides methods for PLMN scanning and selection of a PLMN with discontinuous coverage. In certain aspects, a UE may perform a PLMN scan according to a first schedule when a preferred PLMN of the UE is associated with discontinuous coverage (DC) and perform the PLMN scan according to a second schedule when the preferred PLMN of the UE is not associated with DC.

### INTRODUCTION

This application claims priority to Greek Application No. 20210100645, filed Sep. 29, 2021, which is assigned to the assignee hereof and hereby expressly incorporated by reference in its entirety as if fully set forth below and for all applicable purposes.

Aspects of the present disclosure relate to wireless communications, and more particularly, to techniques for selecting a public land mobile network (PLMN).

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method of wireless communication by a user equipment (UE). The method generally includes performing a public land mobile network (PLMN) scan according to a first schedule when a preferred PLMN of the UE is associated with discontinuous coverage (DC); and performing the PLMN scan according to a second schedule when the preferred PLMN of the UE is not associated with DC.

One aspect provides a user equipment UE including a memory and a processor coupled to the memory. The memory and the processor are configured to: perform a PLMN scan according to a first schedule when a preferred PLMN of the UE is associated with DC; and perform the PLMN scan according to a second schedule when the preferred PLMN of the UE is not associated with DC.

One aspect provides a non-transitory computer readable medium storing code for scheduling of public land mobile network scanning, the code comprising instructions executable by a processor to: perform a PLMN scan according to a first schedule when a preferred PLMN of the UE is associated with DC; and perform the PLMN scan according to a second schedule when the preferred PLMN of the UE is not associated with DC.

One aspect provides an apparatus including means for performing a PLMN scan according to a first schedule when a preferred PLMN of the UE is associated with DC, and means for performing the PLMN scan according to a second schedule when the preferred PLMN of the UE is not associated with DC.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example a base station and user equipment.

FIGS. 3A-3D depict various example aspects of data structures for a wireless communication network.

FIG. 4 is a diagram illustrating an example wireless communication network having a non-terrestrial network entity.

FIG. 5 is a diagram illustrating an example of discontinuous coverage of a non-terrestrial network.

FIG. 6 illustrates an example PLMN scan for initial PLMN selection without accounting for discontinuous coverage.

FIG. 7 illustrates an example PLMN scan for initial PLMN selection accounting for discontinuous coverage, according to certain aspects of the present disclosure.

FIG. 8 illustrates an example of a periodic PLMN scan without accounting for discontinuous coverage.

FIG. 9 illustrates an example of a periodic PLMN scan accounting for discontinuous coverage, according to certain aspects of the present disclosure.

FIG. 10 is a flow diagram illustrating an example method for wireless communications by a user equipment to resume communications with a non-terrestrial network.

FIG. 11 depicts aspects of an example communications device.

### DETAILED DESCRIPTION

Aspects of the present disclosure provide apparatuses, methods, processing systems, and computer-readable mediums for a UE to select a public land mobile network (PLMN). In general, a PLMN is a wireless communication system controlled by an operator that provides services (e.g., voice and/or data services) to devices connected to the PLMN. For example, a PLMN may be associated with one or more base stations (BSs) that provide access to the PLMN. Devices, such as user equipments (UEs), may access the PLMN via the one or more BSs.

As there are many different PLMNs to which a UE can connect, a UE may be configured with processes to search for and connect to a PLMN. For example, depending on the geographic location of a UE, the UE may be within the coverage area of one or more PLMNs. The UE may determine if it is in the coverage area of a PLMN by scanning for signals from the PLMN, such as signals broadcast by BSs of the PLMN that indicate availability for access of the PLMN via a corresponding BS. The UE may select a PLMN that is available and connect to the PLMN, such as by performing a known connection technique, such as using a random access procedure, handover, radio resource control (RRC) signaling, etc. The UE may select the PLMN as part of an initial access procedure where the UE is not currently connected to a PLMN, or as part of a reselection procedure, where the UE is connected to a PLMN and may search for another PLMN.

In some cases, a PLMN may be associated with discontinuous coverage (DC). For example, one or more BSs of the PLMN may be in motion and therefore a particular geographical location may not be continuously provided coverage by a BS of the PLMN. Rather, the coverage provided by BSs of the PLMN to a particular geographical location may be DC whereby there are periods of time where coverage is expected and periods of time where coverage is not expected. This may particularly be the case for certain non-terrestrial networks (NTNs) such as satellite networks, in which the BS transmitters are mounted on satellites. For example, certain satellite operators may intentionally have coverage gaps, such as low Earth orbit (LEO) systems, Internet of Things (IoT) networks, satellites constellations, etc.

In one network deployment scenario, a satellite network operator of a (LEO) satellite system may deploy a satellite constellation that orbits the Earth, in such a way that, for a particular geographic location on the Earth's surface, there is a time gap between a disappearance of the coverage from one orbiting satellite and the next appearance of the coverage from the next orbiting satellite. In some deployments, this time gap, also known as the coverage gap, can be between 10 and 40 minutes long. This may differ from PLMNs that use fixed BSs, such as terrestrial BSs, where coverage by the BS of a particular geographical location is continuous. Though certain aspects may be described with respect to NTNs or satellite networks, the techniques discussed herein may similarly be used for other PLMNs associated with DC.

In some cases, techniques used to perform a PLMN scan for PLMNs with continuous coverage may not be suitable for performing a PLMN scan for PLMNs with DC. In particular, the techniques for a PLMN scan for PLMNs with continuous coverage may cause a UE to perform PLMN scans at times that do not align with the periods of time where coverage is expected for a PLMN with DC, and therefore the UE may not be able to connect to such a PLMN in a particular geographic location, or may inefficiently expend power and resources scanning for a PLMN when it is not available. In certain aspects, a UE is configured with a preferred PLMN, or a list of PLMNs indicating a preference order of PLMNs, and the preferred PLMN may be a PLMN with DC. The UE may be configured to preferably connect to such a preferred PLMN over other PLMNs, and therefore it may be advantageous for the UE to be configured to successfully connect to such a PLMN.

The UE may be configured with a list of PLMNs, indicating the relative priority of each PLMN. When the UE is registered with a PLMN, there may be other PLMNs in the configured list that have a higher priority than the registered PLMN. Such PLMNs may be referred to as preferred PLMNs. The home PLMN (HPLMN) of the UE may be the highest priority PLMN.

Accordingly, certain aspects herein provide techniques for a UE to perform a PLMN scan according to a first schedule suitable for PLMNs with DC, such as where the UE is configured with a preferred PLMN associated with DC. Further, in certain aspects, the UE performs a PLMN scan according to a second schedule suitable for PLMNs without DC, such as where the UE is configured with a preferred PLMN not associated with DC. Advantageously, the UE is more likely to successfully connect to a PLMN with DC according to such techniques, where the UE's preferred PLMN is associated with DC. Further, when the UE's preferred PLMN is not associated with DC, the UE may save power by, for example, not performing PLMN scans as often as it may for PLMNs associated with DC.

For example, in certain aspects, in order to access a preferred PLMN, a user equipment (UE) may first determine whether the preferred PLMN is associated with DC. If so, the UE performs a PLMN scan according to a first schedule. Otherwise, the UE performs the PLMN scan according to a second schedule, such as in order to achieve improved energy efficiency and scan success rate in both cases.

In certain aspects, a preferred PLMN may be a home PLMN (HPLMN) of a UE. An HPLMN may be the PLMN in which a subscriber profile of the UE is stored and maintained. For examples, when a UE is roaming on another PLMN than the HPLMN, the other PLMN may receive subscription information of the UE from the HPLMN.

In certain aspects, a preferred PLMN may be a PLMN having a higher priority that a current PLMN serving the UE. For example, a preferred PLMN may be a PLMN with a higher priority in a list of PLMNs configured at the UE. Such a PLMN may be referred to, for example, as a high priority (HP) PLMN.

In certain aspects, a preferred PLMN may be a PLMN currently serving the UE. A PLMN to which a UE is connected is referred to as a registered PLMN (RPLMN). The RPLMN of a UE may be the HPLMN or a visited PLMN (VPLMN).

In one example, a UE may perform PLMN selection when powering up or waking from sleep mode. If a UE performs PLMN selection during a coverage gap of a preferred PLMN, the UE may be forced to select another, less preferred PLMN. In another example, if the UE is registered with (e.g., “camping” on without an active signaling connection, or connected to with an active signaling connection) only the HPLMN, the UE may not find the HPLMN during a coverage gap and waste energy on performing scans for the HPLMN. Using techniques discussed herein, the UE may avoid performing PLMN selection only during a coverage gap of a preferred PLMN, and accordingly successfully connect to the preferred PLMN and/or avoid wasting energy on performing scans for the preferred PLMN.

In another example, a UE may be configured to periodically search for a preferred PLMN (e.g., while roaming, while already connected to another PLMN, etc.). If the UE, in such cases, follows a coverage pattern of its VPLMN and performs periodic searches according to the coverage pattern of the VPLMN, the UE may not be able to reselect to the preferred PLMN when the configured PLMN scanning periodicity is too infrequent to coincide with a coverage period of the preferred PLMN. For example, even if the UE performs periodic PLMN scans during coverage gaps (e.g., ten to forty minutes) of the VPLMN, the UE may still miss the preferred PLMN signal (e.g., present for about two minutes for each appearance). Using techniques discussed herein, the UE may avoid performing PLMN selection only during a coverage gap of a preferred PLMN, and accordingly successfully connect to the preferred PLMN and/or avoid wasting energy on performing scans for the preferred PLMN.

In yet another example, a timer for periodic search for a preferred PLMN may be set to a value that is suitable for PLMNs with continuous coverage, but is not compatible with the periodic coverage of a preferred PLMN with DC. For example, the UE may be configured to perform a PLMN scan with a periodicity of the timer value meaning once the timer expires the UE performs a PLMN scan and the timer is reset. As such, the UE may miss the periodic coverage of the preferred PLMN even though the preferred PLMN is periodically available. For example, the value of the timer may be between 6 minutes and 8 hours (with a default value of 60 minutes). In the example of a two-minute coverage period of a preferred PLMN, the default timer may not allow the UE to properly scan and select the preferred PLMN. Using techniques discussed herein, the UE may avoid performing PLMN selection only during a coverage gap of a preferred PLMN, and accordingly successfully connect to the preferred PLMN and/or avoid wasting energy on performing scans for the preferred PLMN.

### Introduction to Wireless Communication Networks

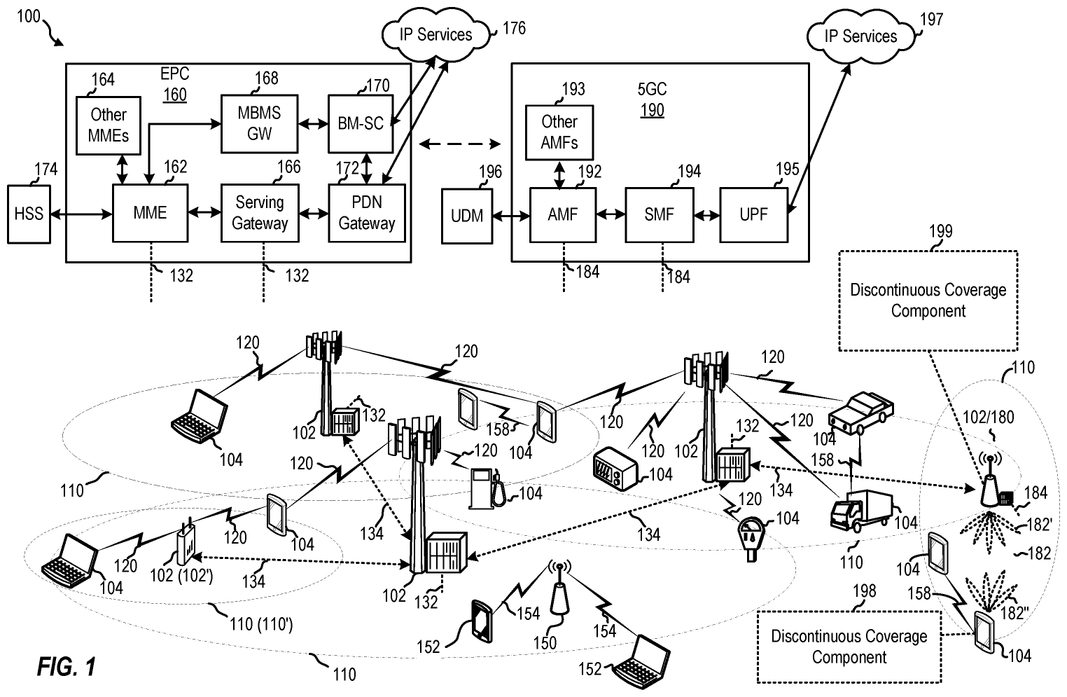

FIG. 1 depicts an example of a wireless communications system 100, in which aspects described herein may be implemented.

Generally, wireless communications system 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Wireless communication network 100 includes discontinuous coverage component 199, which may be configured to establish a connection between a user equipment and a PLMN with DC, as further described herein. Wireless network 100 further includes discontinuous coverage component 198, which may be configured to schedule PLMN scanning for a PLMN with DC, as further described herein.

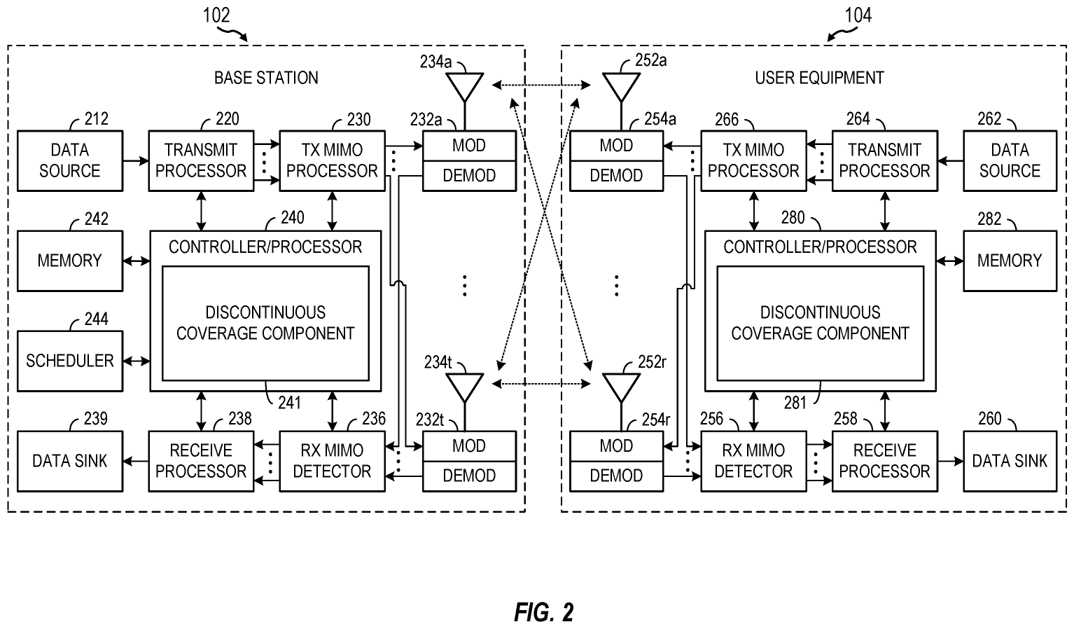

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes a discontinuous coverage component 241, which may be representative of the discontinuous coverage component 199 of FIG. 1. Notably, while depicted as an aspect of controller/processor 240, discontinuous coverage component 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280 includes a discontinuous coverage component 281, which may be representative of the discontinuous coverage component 198 of FIG. 1. Notably, while depicted as an aspect of controller/processor 280, the discontinuous coverage component 281 may be implemented additionally or alternatively in various other aspects of user equipment 104 in other implementations.

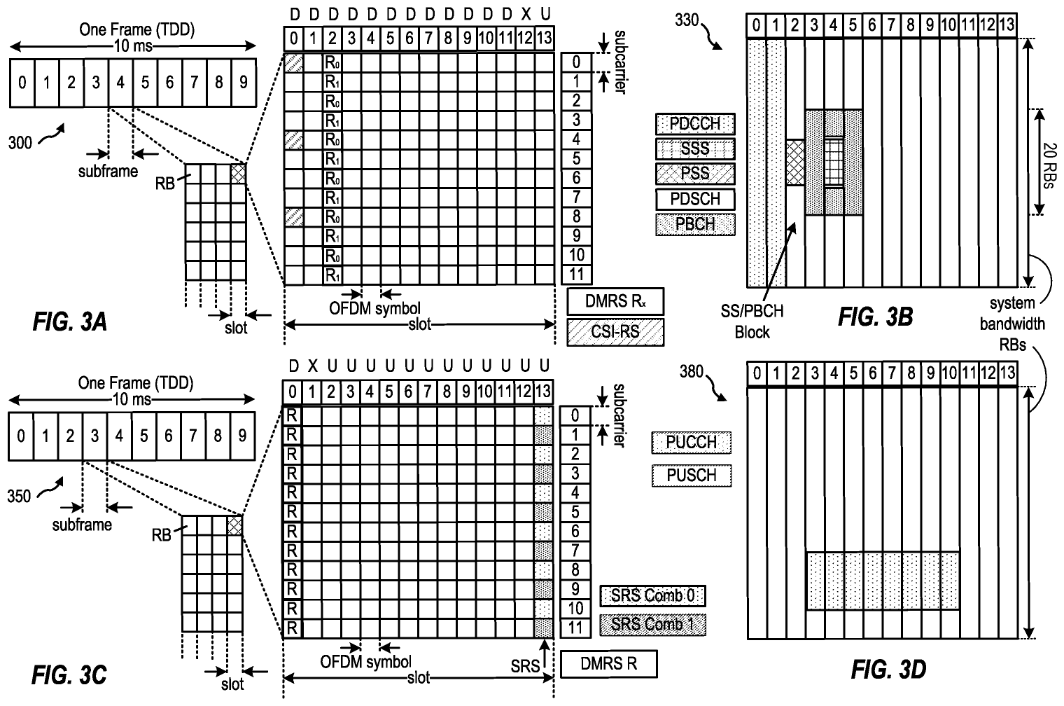

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Example Non-Terrestrial Network (NTN)

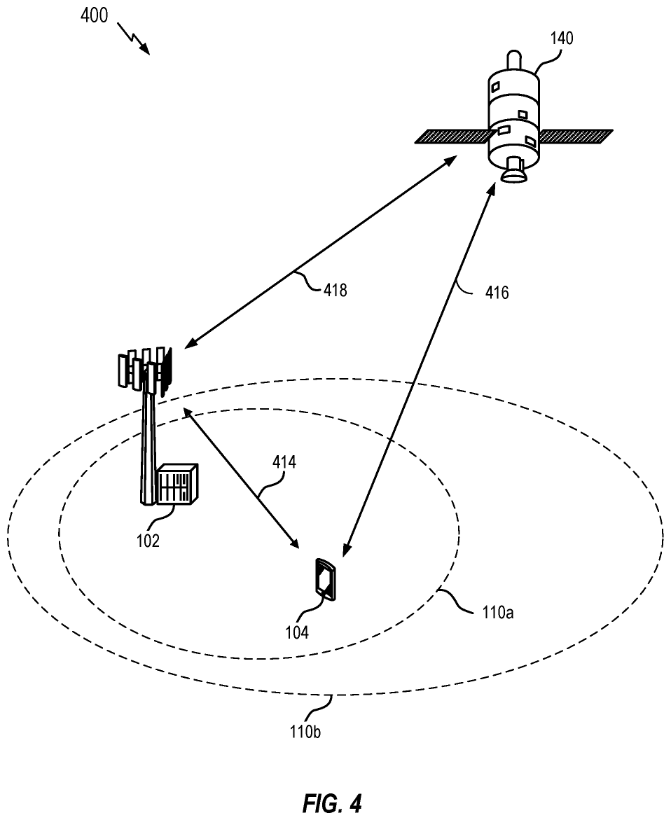

FIG. 4 illustrates an example of a wireless communications network 400 including a non-terrestrial network (NTN) entity 140, which may provide access to a NTN, in which aspects of the present disclosure may be practiced. In some examples, the wireless communications network 400 may implement aspects of the wireless communication network 100. For example, the wireless communications network 400 may include BS 102, UE 104, and the NTN entity 140, such as a satellite. BS 102 may serve a coverage area or cell 110a in cases of a terrestrial network, and the NTN entity 140 may serve the coverage area 110b in cases of an NTN. For example, the NTN entity 140 may perform the function of a BS and provide access to a PLMN with DC. Some NTNs may employ airborne platforms (e.g., a drone or balloon) and/or space-borne platforms (e.g., a satellite).

In certain aspects, the NTN entity 140 may communicate with the BS 102 and UE 104 as part of wireless communications in an NTN. In cases of a terrestrial network, the UE 104 may communicate with the BS 102 over a communication link 414. In the case of NTN wireless communications, the NTN entity 140 may be a serving cell for the UE 104 via a communication link 416. In certain aspects, the NTN entity 140 may act as a relay (or a remote radio head) for the BS 102 and the UE 104. For example, the BS 102 may communicate with the NTN entity 140 via a communication link 418, and the non-terrestrial network entity may relay signaling between the BS 102 and UE 104 via the communication links 416, 418. In some cases according to aspects of the present disclosure, the NTN entity 140 is associated with a preferred PLMN of the UE 104, which is configured to scan for signals from the NTN entity 140 using the techniques disclosed herein.

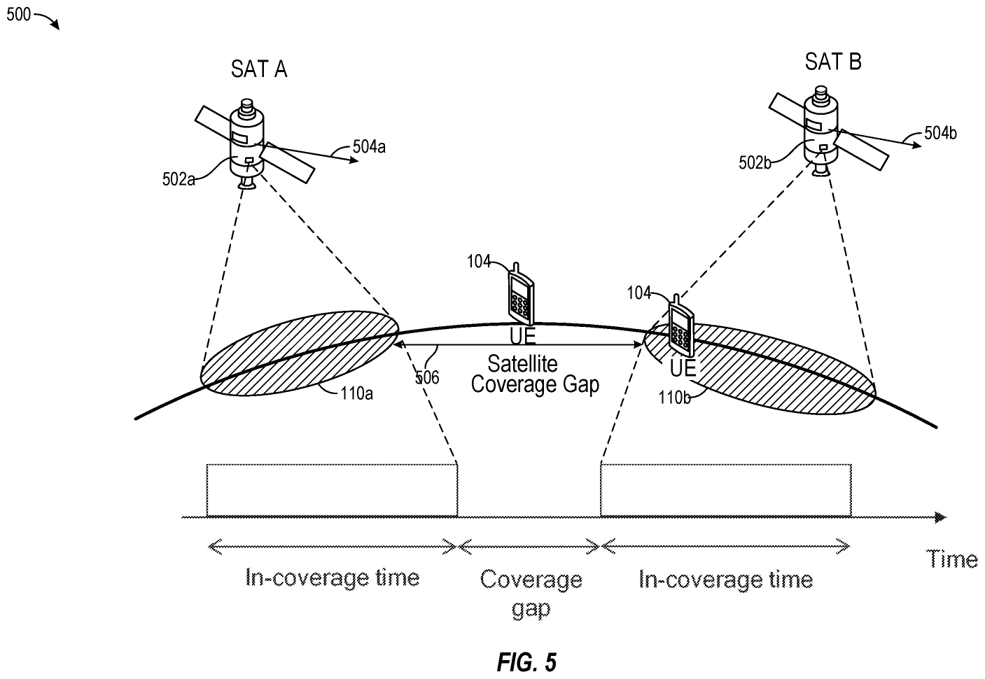

FIG. 5 is a diagram illustrating an example NTN 500 having a coverage gap 506 between two satellites 502a and 502b. As shown, the UE 104 may be on the edge of the coverage area 110b of the second satellite 502b in once instance and may be in the satellite coverage gap 506 in another instance. The coverage gap 506 is between the coverage areas 110a, 110b of the satellites 502a and 502b. As the satellites 502a and 502b orbit generally in the respective directions 504a and 504b, the coverage areas 110a and 110b as well as the coverage gap 506 pass over the UE 104. As a result, the UE 104 experiences discontinuous coverage during the coverage gap 506. That is, as shown in the two separate instances in FIG. 5, when the UE 104 is in the coverage area 110b (or alternatively in the coverage area 110a), the UE is considered to be in an in-coverage state with the NTN 500, and when the UE 104 is in the coverage gap 506, the UE is considered to be in an out-of-coverage state with the NTN 500.

As discussed, the coverage gap may present various issues with respect to the UE performing a PLMN scan for a PLMN associated with NTN 500, such as the UE potentially performing the PLMN scan while in the coverage gap 506, and missing performing the PLMN scan while in a coverage area 110. Accordingly, the present disclosure provides techniques for scanning for a PLMN (e.g., a preferred PLMN) having discontinuous coverage.

Aspects Related to PLMN Scanning for a PLMN with Discontinuous Coverage

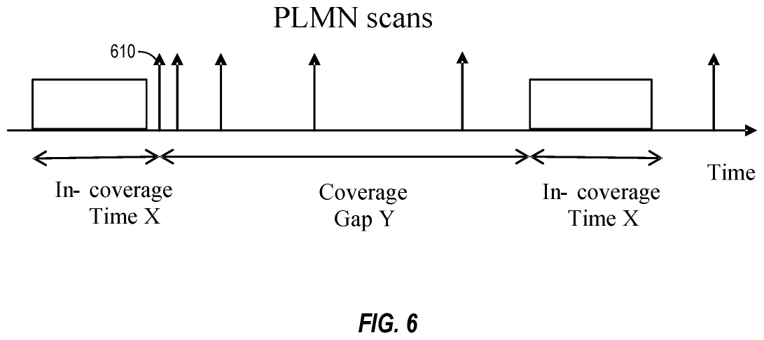

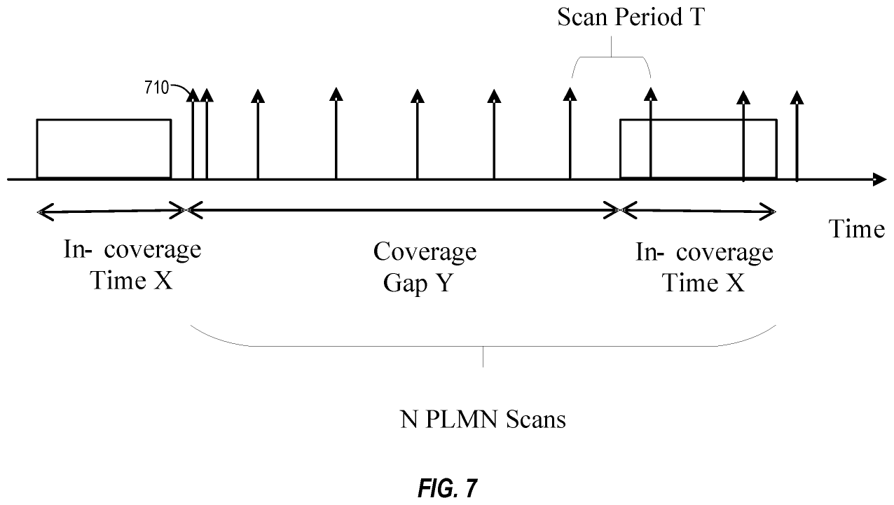

Aspects of the present disclosure provide techniques for PLMN scanning and selection of a PLMN with discontinuous coverage. In certain aspects, a UE may perform a PLMN scan according to a first schedule when a preferred PLMN of the UE is associated with discontinuous coverage (DC) and perform the PLMN scan according to a second schedule when the preferred PLMN of the UE is not associated with DC. For example, in FIGS. 6 and 7, different PLMN scanning schedules are illustrated and discussed below.

In certain aspects, a UE may be configured, such as pre-configured at manufacture, by broadcast signaling from a PLMN, by dedicated signaling from a PLMN, through an over the air update, by signaling from a previous camping on/connection to/registration to the PLMN etc., with an indication about whether a PLMN has DC or not, such as prior to current selection of the PLMN by the UE. In certain aspects, the indication may be stored in a memory of the UE. In certain aspects, the indication may be stored in and accessed from a subscriber identity module (SIM) installed in the UE. In certain aspects, the indication may be received from a preferred PLMN.

In certain aspects, when the indication is provided via broadcast signaling, the indication may be included in the system information provided on the broadcast channel of the satellite radio cell.

In certain aspects, the indication may include ephemeris (e.g., trajectory and/or position information) for one or more BSs (e.g., satellites) associated with the preferred PLMN. For example, in certain aspects, the UE may be configured to (i) determine one or more expected coverage periods where at least one BS of the preferred PLMN provides coverage in a geographical location of the UE based on the ephemeris; and/or (ii) determine one or more expected coverage gap periods where no BS of the preferred PLMN provides coverage in the geographical location of the UE based on the ephemeris. In certain aspects, the UE is configured with ephemeris separately from the indication, and the indication may be a simple indication (e.g., flag) of an association with DC or not for the PLMN.

In certain aspects, the indication explicitly indicates a coverage gap schedule for a PLMN with DC. For example, the coverage gap schedule may indicate a duration X indicating the duration of time during which coverage is expected, and/or a duration Y indicating the duration of time during which coverage is not expected, wherein a sequence of X and Y recurs in time. In certain aspects, the UE is configured with a coverage gap schedule separately from the indication, and the indication may be a simple indication (e.g., flag) of an association with DC or not for the PLMN. In certain aspects, the UE is configured with a default coverage gap schedule (e.g., default X and/or Y values) that the UE uses for a PLMN indicated as having DC, but for which the UE is not configured with the actual coverage gap schedule of the PLMN. In certain aspects, the UE may be configured to determine a coverage gap schedule for a PLMN with DC through a previous connection/registration with the PLMN.

In certain aspects, the schedule for PLMN scan for a PLMN with DC may be based on the expected coverage periods and/or the expected coverage gap periods of the PLMN, such as based on ephemeris or a coverage gap schedule, as discussed further herein. For example, in certain aspects, the schedule for PLMN scan for a PLMN with DC may indicate to perform a PLMN scan during an expected coverage period. In certain aspects, the schedule for PLMN scan for a PLMN with DC may indicate to delay a PLMN scan until the UE is expected to be in coverage of the preferred PLMN. In certain aspects, the schedule for PLMN scan for a PLMN with DC indicates to perform a PLMN scan more frequently than the schedule for PLMN scan for a PLMN without DC.

In certain aspects, a BS of the preferred PLMN or another PLMN may transmit (e.g., broadcast) signaling, such as a system information block (SIB) broadcast or a non-access stratum (NAS) message, that includes the indication, coverage gap schedule, and/or ephemeris. The UE may receive such signaling. In certain aspects, when a UE does not receive an indication that a preferred PLMN has DC, the UE is configured to treat the preferred PLMN as not having DC.

In certain aspects, the UE may be configured to operate in either a DC mode (also referred to as a satellite mode) or not in a DC mode. The UE may be so configured by a PLMN to which the UE is registered, based on a previous configuration, or the like. In the DC mode, the UE may perform PLMN scans as though its preferred PLMN has DC, whether or not it has an explicit indication that the preferred PLMN has DC. When not in the DC mode, the UE may perform PLMN scans as though its preferred PLMN does not have DC.

FIG. 6 illustrates an example PLMN scan for initial PLMN selection without accounting for discontinuous coverage, such as when the indication provides that the preferred PLMN does not have DC. For example, the schedule for PLMN scan shown in FIG. 6 may be used in instances where the UE is not currently connected to a PLMN. PLMN scanning instances 610 indicate instances in time that the UE performs a PLMN scan. As shown, the schedule by which the UE performs the PLMN scan for initial selection of a PLMN when the preferred PLMN is not associated with DC includes an increasing (e.g., exponentially increasing) period of time between PLMN scans 610 as the UE scans for the preferred PLMN and does not receive signaling for the preferred PLMN. As shown, the PLMN scanning instances 610 may have a gradually increasing time interval. Such PLMN scan schedule may provide power saving benefits with terrestrial networks that do not have DC (e.g., the unavailability of the network being more permanent at the location of the UE), but may inadvertently miss in-coverage time of a preferred PLMN with DC. As shown, if the same scanning profile or pattern is used when the preferred PLMN has DC, as the scanning interval increases, an in-coverage time may be completely missed because the scanning interval is much greater than the in-coverage time.

FIG. 7 illustrates an example PLMN scan for initial PLMN selection accounting for discontinuous coverage, such as when a UE receives an indication that a preferred PLMN has DC, according to certain aspects of the present disclosure. For example, the schedule for PLMN scan shown in FIG. 7 may be used in instances where the UE is not currently connected to a PLMN. As shown, the UE may perform PLMN scanning for initial selection to a PLMN according to a different schedule than that of FIG. 6. The scanning instances 710 may be configured to occur periodically, such as with a fixed periodicity between scanning instances 710. The periodicity of the scanning instances 710 may be configured based on a duration X indicating the duration of time during which coverage is expected, and/or a duration Y indicating the duration of time during which coverage is not expected, so as to cause the UE to perform a PLMN scan during a time when coverage is expected for the preferred PLMN. As shown, durations X and Y recur in time periodically. In certain aspects, the UE is scheduled to perform at least N PLMN scans during an interval X+Y, meaning an interval of coverage and a coverage gap. In certain aspects, N is set to N=(Y+X)/X. In certain aspects, the UE is configured to perform a PLMN with a periodicity T. In certain aspects, T<X. In certain aspects T<=X. In certain aspects, T=X.

For example, when X=2 min, and Y=30 min, there may be N=16 PLMN scan instances 710 every 32 minutes, calculated from (2+30)/2. In certain aspects, if the UE is not configured with values for X and/or Y for a given PLMN indicated as being a PLMN with DC, a default value(s) for X and/or Y may be used. In some cases, the UE may update the configuration of X and/or Y based on history of camping on a PLMN. In some aspects, in addition to or alternative to updating the periodicity T of performing PLMN scans, the UE may also be configured to delay a PLMN scan until satellite coverage is expected. In some cases, the UE may determine the X and/or Y values based on previous registrations with the preferred PLMN. In some cases, the UE may determine the X and/or Y values based on information signaled by the preferred PLMN. For example, the information signaled by the preferred PLMN may include ephemeris of one or more satellites associated with the preferred PLMN.

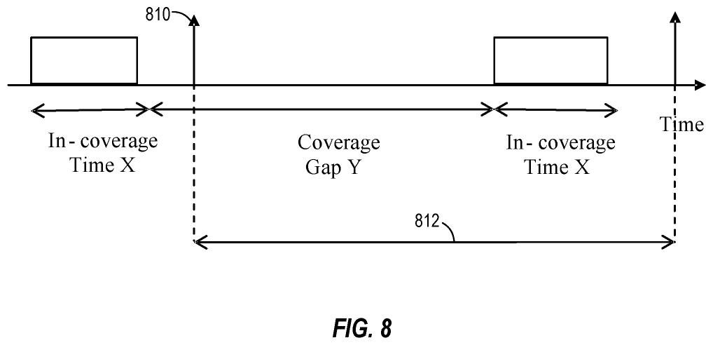

FIG. 8 illustrates an example of a periodic PLMN scan for PLMN reselection without accounting for discontinuous coverage, such as when the indication provides that the preferred PLMN does not have DC. For example, the schedule for PLMN scan shown in FIG. 8 may be used in instances where the UE is currently connected to a PLMN and scanning to connect/reselect to a preferred PLMN. As shown, the UE may be configured to perform PLMN scans with a periodicity 812. For example, the UE may be configured with a minimum search timer (“minSearchTimer”) indicating the minimum value of the periodicity 812 for the UE to use to perform PLMN scans. In certain aspects, the UE, when conforming to the minimum search timer, does not perform a PLMN scan more than once during the time duration indicated by the minimum search timer.

In an example, wherein the minimum search timer value is 60 minutes and the example coverage gap Y is 40 minutes, as shown, the scanning instances 810 may miss the in-coverage time X of the preferred PLMN.

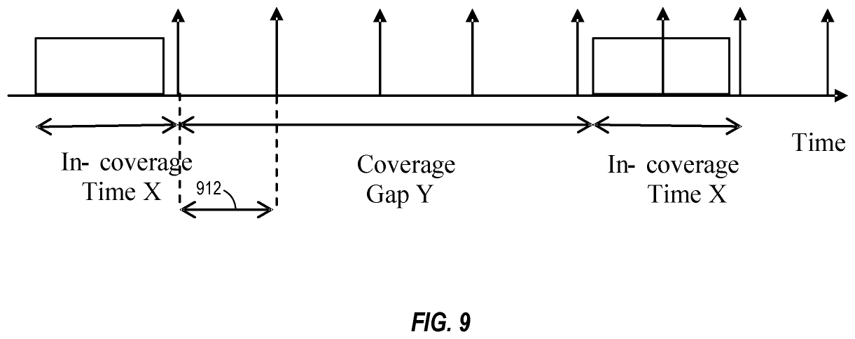

In certain aspects, the UE is configured to ignore or not conform to the minimum search timer when the preferred PLMN has DC, such as by performing PLMN scans with a periodicity that is less than the minimum search timer, such as discussed with respect to FIG. 9.

FIG. 9 illustrates an example of a periodic PLMN scan accounting for discontinuous coverage, such as when a UE receives an indication that a preferred PLMN has DC, according to certain aspects of the present disclosure. For example, the schedule for PLMN scan shown in FIG. 9 may be used in instances where the UE is currently connected to a PLMN and scanning to connect to a preferred PLMN. As shown, the UE may adjust the periodicity 912 at which it performs PLMN scans to be less than the configured minimum search timer, so as to increase the likelihood that the PLMN scan is performed during an in-coverage time X.

In certain aspects, the UE may determine the periodicity 912 as the minimum or smaller value of the configured minimum search timer and a periodicity T. In certain aspects, T is calculated based on a duration X indicating the duration of time during which coverage is expected, and/or a duration Y indicating the duration of time during which coverage is not expected, so as to cause the UE to perform a PLMN scan during a time when coverage is expected for the preferred PLMN. As shown, durations X and Y recur in time periodically. In certain aspects, T<X. In certain aspects T<=X. In certain aspects, T=X. In certain aspects, the periodicity 912 is less than a minimum period of satellite visibility (e.g., less than X), such as at a geographical location of the UE.

Therefore, using this schedule with a periodicity 912 that does not need to conform to the minimum search timer, the UE may select the preferred PLMN. When the in-coverage time and/or the coverage gap is not known, the UE may use one or more default values to update the scanning periodicity value.

In certain aspects, if the UE is not configured with values for X and/or Y for a given PLMN indicated as being a PLMN with DC, a default value(s) for X and/or Y may be used (e.g., a default value of 10 minutes for X). In some cases, the UE may update the configuration of X and/or Y based on history of camping on a PLMN. In some aspects, in addition to or alternative to updating the periodicity T of performing PLMN scans, the UE may also be configured to delay a PLMN scan until satellite coverage is expected. In some cases, the UE may determine the X and/or Y values based on previous registrations with the preferred PLMN. In some cases, the UE may determine the X and/or Y values based on information signaled by the preferred PLMN. For example, the information signaled by the preferred PLMN may include ephemeris of one or more satellites associated with the preferred PLMN.

### Example Method

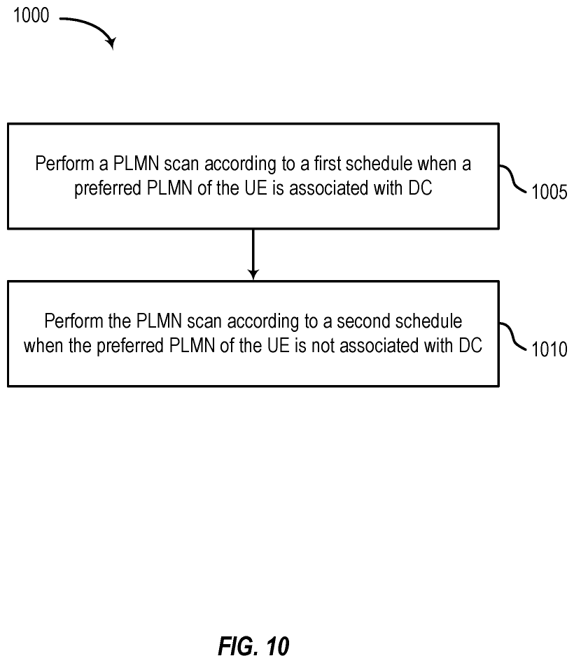

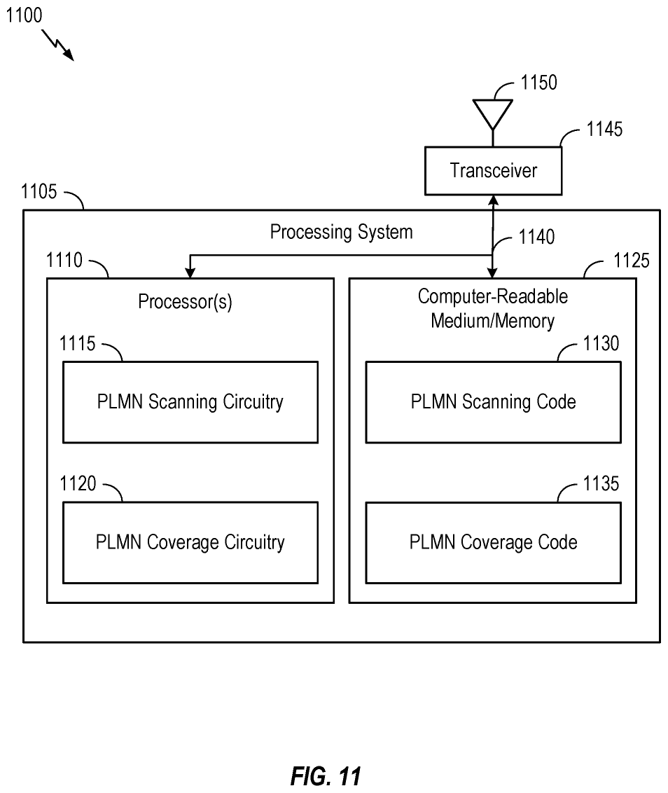

FIG. 10 shows an example of a method 1000 for scheduling of public land mobile network scanning according to aspects of the present disclosure. In some aspects, a user equipment, such as UE 104 of FIGS. 1 and 2, or processing system 1105 of FIG. 11, may perform the method 1000.

At operation 1005, the system performs a PLMN scan according to a first schedule when a preferred PLMN of the UE is associated with DC. In some cases, the operations of this step refer to, or may be performed by, PLMN scanning circuitry as described with reference to FIG. 11.

At operation 1010, the system performs the PLMN scan according to a second schedule when the preferred PLMN of the UE is not associated with DC. In some cases, the operations of this step refer to, or may be performed by, PLMN scanning circuitry as described with reference to FIG. 11.

In some aspects, the preferred PLMN is at least one of a HPLMN, a PLMN having a higher priority than a current PLMN serving the UE, or the current PLMN serving the UE.

In some aspects, the memory is configured to store an indication of whether the preferred PLMN is associated with DC, the memory and the processor are configured to access the indication from a SIM configured to store the indication, the memory and the processor are configured to receive the indication from the preferred PLMN, or some combination thereof. In some aspects, the indication comprises ephemeris for one or more satellites associated with the preferred PLMN. In some aspects, the indication is received in a SIB broadcast or in a NAS Message.

In some aspects, whether the preferred PLMN is associated with DC is based on a mode of operation of the UE. In some aspects, the first schedule is based on at least one of an expected coverage period when the UE is expected to be in coverage of the preferred PLMN or an expected coverage gap period when the UE is expected to not be in coverage of the preferred PLMN.

In some aspects, the method 1000 further includes determining the at least one of the expected coverage period or the expected coverage gap period based on a previous registration by the UE with the preferred PLMN.

In some aspects, the method 1000 further includes determining the at least one of the expected coverage period or the expected coverage gap period based on information signaled by the preferred PLMN.

In some aspects, the information signaled by the preferred PLMN comprises ephemeris of one or more satellites associated with the preferred PLMN.

In some aspects, the second schedule indicates to perform the PLMN scan periodically with a periodicity that conforms to a minimum search timer. In some aspects, the first schedule indicates to perform the PLMN scan with a second periodicity that does not conform to the minimum search timer based on the at least one of the expected coverage period or the expected coverage gap period.

In some aspects, the second periodicity is less than the minimum search timer. In some aspects, the second periodicity is less than a minimum period of satellite visibility.

In some aspects, the first schedule is based on at least one configured value for the at least one of the expected coverage period or the expected coverage gap period when the at least one of the expected coverage period or the expected coverage gap period is configured at the UE. In some aspects, the first schedule is based on at least one default value for the at least one of the expected coverage period or the expected coverage gap period when the at least one of the expected coverage period or the expected coverage gap period is not configured at the UE.

In some aspects, the first schedule indicates to delay the PLMN scan until the UE is expected to be in coverage of the preferred PLMN based on the at least one of the expected coverage period or the expected coverage gap period. In some aspects, whether the preferred PLMN is associated with DC is based on whether the at least one of the expected coverage period or the expected coverage gap period is configured at the UE for the preferred PLMN.

In some aspects, the first schedule indicates to perform the PLMN scan more frequently than the second schedule.

### Example Wireless Communication Devices

FIG. 11 depicts an example communications device 1100 that includes various components operable, configured, or adapted to perform operations for the techniques disclosed herein, such as the operations depicted and described with respect to FIG. 10. In some examples, communication device may be a user equipment 104 as described, for example with respect to FIGS. 1 and 2.

Communications device 1100 includes a processing system 1105 coupled to a transceiver 1145 (e.g., a transmitter and/or a receiver). Transceiver 1145 is configured to transmit (or send) and receive signals for the communications device 1100 via an antenna 1150, such as the various signals as described herein. A transceiver 1145 may communicate bi-directionally, via antennas 1150, wired, or wireless links as described above. For example, the transceiver 1145 may represent a wireless transceiver 1145 and may communicate bi-directionally with another wireless transceiver 1145. The transceiver 1145 may also include or be connected to a modem to modulate the packets and provide the modulated packets to for transmission, and to demodulate received packets. In some examples, transceiver 1145 may be tuned to operate at specified frequencies. For example, a modem can configure the transceiver 1145 to operate at a specified frequency and power level based on the communication protocol used by the modem.

Processing system 1105 may be configured to perform processing functions for communications device 1100, including processing signals received and/or to be transmitted by communications device 1100. Processing system 1105 includes one or more processors 1110 coupled to a computer-readable medium/memory 1125 via a bus 1140.

In some examples, one or more processors 1110 may include one or more intelligent hardware devices, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the one or more processors 1110 are configured to operate a memory array using a memory controller. In other cases, a memory controller is integrated into the one or more processors 1110. In some cases, the one or more processors 1110 are configured to execute computer-readable instructions stored in a memory to perform various functions. In some embodiments, one or more processors 1110 include special purpose components for modem processing, baseband processing, digital signal processing, or transmission processing.

In certain aspects, computer-readable medium/memory 1125 is configured to store instructions (e.g., computer-executable code) that when executed by the one or more processors 1110, cause the one or more processors 1110 to perform the operations illustrated in FIG. 10, or other operations for performing the various techniques discussed herein. In one aspect, computer-readable medium/memory 1125 includes PLMN scanning code 1130 and PLMN coverage code 1135.

Examples of a computer-readable medium/memory 1125 include random access memory (RAM), read-only memory (ROM), solid state memory, a hard drive, a hard disk drive, etc. In some examples, computer-readable medium/memory 1125 is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

Various components of communications device 1100 may provide means for performing the methods described herein, including with respect to FIG. 10.

In some examples, means for transmitting or sending (or means for outputting for transmission) may include the transceivers 254 and/or antenna(s) 252 of the user equipment 104 illustrated in FIG. 2 and/or transceiver 1145 and antenna 1150 of the communication device in FIG. 11.

In some examples, means for receiving (or means for obtaining) may include the transceivers 254 and/or antenna(s) 252 of the user equipment 104 illustrated in FIG. 2 and/or transceiver 1145 and antenna 1150 of the communication device in FIG. 11.

In some examples, means for performing a PLMN scan according to different schedules depending on whether the preferred PLMN is associated with DC may include various processing system 1105 components, such as: the one or more processors 1110 in FIG. 11, or aspects of the user equipment 104 depicted in FIG. 2, including receive processor 258, transmit processor 264, TX MIMO processor 266, and/or controller/processor 280.

In one aspect, one or more processors 1110 includes PLMN scanning circuitry 1115 and PLMN coverage circuitry 1120.

According to some aspects, PLMN scanning circuitry 1115 performs a PLMN scan according to a first schedule when a preferred PLMN of the UE is associated with DC. In some examples, PLMN scanning circuitry 1115 performs the PLMN scan according to a second schedule when the preferred PLMN of the UE is not associated with DC. In some aspects, the preferred PLMN is at least one of a HPLMN, a PLMN having a higher priority than a current PLMN serving the UE, or the current PLMN serving the UE. In some aspects, the memory is configured to store an indication of whether the preferred PLMN is associated with DC, the memory and the processor are configured to access the indication from a SIM configured to store the indication, the memory and the processor are configured to receive the indication from the preferred PLMN, or some combination thereof. In some aspects, the indication includes ephemeris for one or more satellites associated with the preferred PLMN. In some aspects, the indication is received in a SIB broadcast or in a NAS Message. In some examples, whether the preferred PLMN is associated with DC is based on a mode of operation of the UE.

In some aspects, the first schedule is based on at least one of an expected coverage period when the UE is expected to be in coverage of the preferred PLMN or an expected coverage gap period when the UE is expected to not be in coverage of the preferred PLMN. In some examples, PLMN coverage circuitry 1120 determines the at least one of the expected coverage period or the expected coverage gap period based on a previous registration by the UE with the preferred PLMN. In some examples, PLMN coverage circuitry 1120 determines the at least one of the expected coverage period or the expected coverage gap period based on information signaled by the preferred PLMN.

In some aspects, the information signaled by the preferred PLMN includes ephemeris of one or more satellites associated with the preferred PLMN. In some aspects, the second schedule indicates to perform the PLMN scan periodically with a periodicity that conforms to a minimum search timer. In some aspects, the first schedule indicates to perform the PLMN scan with a second periodicity that does not conform to the minimum search timer based on the at least one of the expected coverage period or the expected coverage gap period. In some aspects, the second periodicity is less than the minimum search timer. In some aspects, the second periodicity is less than a minimum period of satellite visibility.

In some aspects, the first schedule is based on at least one configured value for the at least one of the expected coverage period or the expected coverage gap period when the at least one of the expected coverage period or the expected coverage gap period is configured at the UE. In some aspects, the first schedule is based on at least one default value for the at least one of the expected coverage period or the expected coverage gap period when the at least one of the expected coverage period or the expected coverage gap period is not configured at the UE. In some aspects, the first schedule indicates to delay the PLMN scan until the UE is expected to be in coverage of the preferred PLMN based on the at least one of the expected coverage period or the expected coverage gap period. In some examples, whether the preferred PLMN is associated with DC is based on whether the at least one of the expected coverage period or the expected coverage gap period is configured at the UE for the preferred PLMN. In some aspects, the first schedule indicates to perform the PLMN scan more frequently than the second schedule.

Notably, FIG. 11 is just an example, and many other examples and configurations of communication device are possible.

### Example Clauses

Implementation examples are described in the following numbered clauses:

Clause 1: A method of wireless communication by a UE, comprising: performing a PLMN scan according to a first schedule when a preferred PLMN of the UE is associated with DC and performing the PLMN scan according to a second schedule when the preferred PLMN of the UE is not associated with DC.

Clause 2: The method of clause 1, the preferred PLMN is at least one of a HPLMN, a PLMN having a higher priority than a current PLMN serving the UE, or the current PLMN serving the UE.

Clause 3: The method of any one of clauses 1-2, wherein: the memory is configured to store an indication of whether the preferred PLMN is associated with DC, the memory and the processor are configured to access the indication from a SIM configured to store the indication, the memory and the processor are configured to receive the indication from the preferred PLMN, or some combination thereof.

Clause 4: The method of clause 3, wherein: the indication comprises ephemeris for one or more satellites associated with the preferred PLMN.

Clause 5: The method of clause 3, wherein: the indication is received in a SIB broadcast or in a NAS Message.

Clause 6: The method of any one of clauses 1-5, wherein: whether the preferred PLMN is associated with DC is based on a mode of operation of the UE.

Clause 7: The method of any one of clauses 1-6, wherein: the first schedule is based on at least one of an expected coverage period when the UE is expected to be in coverage of the preferred PLMN or an expected coverage gap period when the UE is expected to not be in coverage of the preferred PLMN.

Clause 8: The method of clause 7, further comprising: determining the at least one of the expected coverage period or the expected coverage gap period based on a previous registration by the UE with the preferred PLMN.

Clause 9: The method of clause 7, further comprising: determining the at least one of the expected coverage period or the expected coverage gap period based on information signaled by the preferred PLMN.

Clause 10: The method of clause 9, wherein: the information signaled by the preferred PLMN comprises ephemeris of one or more satellites associated with the preferred PLMN.

Clause 11: The method of clause 7, wherein: the second schedule indicates to perform the PLMN scan periodically with a periodicity that conforms to a minimum search timer. In some aspects, the first schedule indicates to perform the PLMN scan with a second periodicity that does not conform to the minimum search timer based on the at least one of the expected coverage period or the expected coverage gap period.

Clause 12: The method of clause 11, wherein: the second periodicity is less than the minimum search timer.

Clause 13: The method of clause 11, wherein: the second periodicity is less than a minimum period of satellite visibility.

Clause 14: The method of clause 7, wherein: the first schedule is based on at least one configured value for the at least one of the expected coverage period or the expected coverage gap period when the at least one of the expected coverage period or the expected coverage gap period is configured at the UE. In some aspects, the first schedule is based on at least one default value for the at least one of the expected coverage period or the expected coverage gap period when the at least one of the expected coverage period or the expected coverage gap period is not configured at the UE.

Clause 15: The method of clause 7, wherein: the first schedule indicates to delay the PLMN scan until the UE is expected to be in coverage of the preferred PLMN based on the at least one of the expected coverage period or the expected coverage gap period.

Clause 16: The method of clause 7, wherein: whether the preferred PLMN is associated with DC is based on whether the at least one of the expected coverage period or the expected coverage gap period is configured at the UE for the preferred PLMN.

Clause 17: The method of any one of clauses 1-16, the first schedule indicates to perform the PLMN scan more frequently than the second schedule.

Clause 18: A processing system, comprising: a memory and a processor configured to perform a method in accordance with any one of Clauses 1-17.

Clause 19: A processing system, comprising means for performing a method in accordance with any one of Clauses 1-17.

Clause 20: A non-transitory computer-readable medium comprising computer-executable instructions that, when executed by one or more processors of a processing system, cause the processing system to perform a method in accordance with any one of Clauses 1-17.

Clause 21: A computer program product embodied on a computer-readable storage medium comprising code for performing a method in accordance with any one of Clauses 1-17.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mm Wave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of selecting a public land mobile network associated with discontinuous coverage. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment (UE), comprising:
at least one memory; and
at least one processor coupled to the at least one memory, the at least one memory and the at least one processor configured to cause the UE to:
perform a public land mobile network (PLMN) scan according to a first schedule when a preferred PLMN of the UE is associated with discontinuous coverage (DC); and
perform the PLMN scan according to a second schedule when the preferred PLMN of the UE is not associated with DC.

2. The UE of claim 1, wherein the preferred PLMN is at least one of:
a home PLMN (HPLMN);
a PLMN having a higher priority than a current PLMN serving the UE; or
the current PLMN serving the UE.

3. The UE of claim 1, wherein at least one of:
the at least one memory is configured to store an indication of whether the preferred PLMN is associated with DC;
the at least one memory and the at least one processor are configured to cause the UE to access the indication from a subscriber identity module (SIM) configured to store the indication; or
the at least one memory and the at least one processor are configured to cause the UE to receive the indication from the preferred PLMN.

4. The UE of claim 3, wherein the indication comprises ephemeris for one or more satellites associated with the preferred PLMN.

5. The UE of claim 3, wherein the indication is received in a System Information Block (SIB) broadcast or in a Non-Access Stratum (NAS) Message.

6. The UE of claim 1, wherein whether the preferred PLMN is associated with DC is based on a mode of operation of the UE.

7. The UE of claim 1, wherein the first schedule is based on at least one of an expected coverage period when the UE is expected to be in coverage of the preferred PLMN or an expected coverage gap period when the UE is expected to not be in coverage of the preferred PLMN.

8. The UE of claim 7, wherein the at least one memory and the at least one processor are further configured to cause the UE to:
determine the at least one of the expected coverage period or the expected coverage gap period based on a previous registration by the UE with the preferred PLMN.

9. The UE of claim 7, wherein the at least one memory and the at least one processor are further configured to cause the UE to:
determine the at least one of the expected coverage period or the expected coverage gap period based on information signaled by the preferred PLMN.

10. The UE of claim 9, wherein the information signaled by the preferred PLMN comprises ephemeris of one or more satellites associated with the preferred PLMN.

11. The UE of claim 7, wherein:
the second schedule indicates to perform the PLMN scan periodically with a periodicity that conforms to a minimum search timer; and
the first schedule indicates to perform the PLMN scan with a second periodicity that does not conform to the minimum search timer based on the at least one of the expected coverage period or the expected coverage gap period.

12. The UE of claim 11, wherein the second periodicity is less than the minimum search timer.

13. The UE of claim 11, wherein the second periodicity is less than a minimum period of satellite visibility.

14. The UE of claim 7, wherein:
when the at least one of the expected coverage period or the expected coverage gap period is configured at the UE, the first schedule is based on at least one configured value for the at least one of the expected coverage period or the expected coverage gap period; and
when the at least one of the expected coverage period or the expected coverage gap period is not configured at the UE, the first schedule is based on at least one default value for the at least one of the expected coverage period or the expected coverage gap period.

15. The UE of claim 7, wherein the first schedule indicates to delay the PLMN scan until the UE is expected to be in coverage of the preferred PLMN based on the at least one of the expected coverage period or the expected coverage gap period.

16. The UE of claim 7, wherein whether the preferred PLMN is associated with DC is based on whether the at least one of the expected coverage period or the expected coverage gap period is configured at the UE for the preferred PLMN.

17. The UE of claim 1, wherein the first schedule indicates to perform the PLMN scan more frequently than the second schedule.

18. A method for wireless communications by a user equipment (UE), comprising:
performing a public land mobile network (PLMN) scan according to a first schedule when a preferred PLMN of the UE is associated with discontinuous coverage (DC); and
performing the PLMN scan according to a second schedule when the preferred PLMN of the UE is not associated with DC.

19-28. (canceled)

29. A non-transitory computer readable medium storing code for scheduling of public land mobile network scanning, the code comprising instructions executable by a processor to:
perform a public land mobile network (PLMN) scan according to a first schedule when a preferred PLMN of a user equipment (UE) is associated with discontinuous coverage (DC); and
perform the PLMN scan according to a second schedule when the preferred PLMN of the UE is not associated with DC.

30. (canceled)
